(19) United States
(12) Patent Application Publication
(10) Pub. No.: US 2025/0170810 A1
(43) Pub. Date: May 29, 2025

(54) VACUUM INFUSION PROCESS INTO IN-SITU POWDER

(71) Applicant: William Kreysler & Associates, Inc, American Canyon, CA (US)

(72) Inventors: William Kreysler, American Canyon, CA (US); Timothy Oliver, San Francisco, CA (US); Matt Hettinger, American Canyon, CA (US)

(73) Assignee: William Kreysler & Associates, Inc, American Canyon, CA (US)

(21) Appl. No.: 18/957,028

(22) Filed: Nov. 22, 2024

Related U.S. Application Data
(60) Provisional application No. 63/602,799, filed on Nov. 27, 2023.

(51) Int. Cl. B32B 27/20; B32B 5/10

(52) U.S. Cl. CPC B32B 27/20; B32B 5/10; B32B 2262/101; B32B 2264/10; B32B 2264/303; B32B 2305/08; B32B 2305/30; B32B 2307/3065

(57) ABSTRACT

A method is provided for fabricating fiber reinforced plastic (FRP) panels filled with flame-retardant fillers. The method may include pre-treating fiber reinforcement with a polymer binder, spreading fillers of a selected size over the polymer binder, and forming a dry stack including the fiber reinforcement and the fillers. The method may also include infusing a polymer resin into the dry stack using a vacuum infusion process and forming a fiber reinforced plastic (FRP) laminate including the fiber reinforcement and substantially uniformly distributed fillers embedded within a polymer matrix formed from the polymer resin, the fillers having a filler loading of at least 70 parts per hundred parts of infused resin (phr).

### CROSS-REFERENCE TO RELATED PATENT APPLICATIONS

This patent application claims the benefit under 35 U.S.C. § 119(e) of U.S. Patent Application Ser. No. 63/602,799, entitled “Vacuum Infusion Process into in-situ powder,” filed on Nov. 27, 2023, which is incorporated herein by reference in its entirety.

### FIELD

The disclosure is directed to the fabrication of fiber-reinforced polymer (FRP) laminates with flame-retardant fillers using a vacuum infusion process. In particular, the FRP laminates have much higher filler loading than conventional infusion approaches.

### BACKGROUND

In a typical hand lay-up for fabricating FRP laminates, the dry fiberglass is laid into a mold and manually wet out using brushes, rollers, or through other means. The typical hand lay-up usually results in excess of 100% fabric weight by resin. Resin alone is very brittle, so any excess resin may weaken the composite part. An improvement is to use a vacuum bag to suck excess resin out of the laminate, which is referred to as vacuum bagging. The vacuum bagging can improve the fiber-to-resin ratio, and thus can result in a stronger and lighter product.

While the vacuum bagging improves on the hand lay-up, there is still a hand lay-up involved. The laminate may begin in an oversaturated state. Vacuum pressure may remove most of the excess resin, but the amount removed still depends on a variety of variables, such as reinforcement material, resin, time factors, among others. The vacuum bagging can reduce the excess resin significantly; however, it is still not ideal and can lead to additional problems.

The vacuum infusion process offers a better fiber-to-resin ratio than the vacuum bagging. The vacuum infusion process takes a different approach, where a vacuum is drawn while the materials are still dry. As such, resin is infused using vacuum pressure. Rather than starting with excess resin and driving the excess resin out, the vacuum infusion process starts without any resin and pushes resin in. As a result, a minimum amount of resin may be introduced, which lowers weight, increases strength, and maximizes the properties of fiber and resin. Parts constructed using the vacuum infusion can approach prepreg levels of resin content.

The vacuum infusion process uses vacuum pressure to drive a polymer resin into a dry fiberglass, which is placed into a mold. Then, a vacuum is applied before the polymer resin is introduced. Once the vacuum is achieved, the polymer resin can be allowed to bleed into or suck into the space of the dry fiberglass and can gradually infuse the dry fiberglass with the resin.

### BRIEF SUMMARY

In one aspect, a method is provided for fabricating fiber reinforced plastic (FRP) panels filled with flame-retardant fillers. The method may include pre-treating fiber reinforcement with a polymer binder. The method may also include spreading fillers of a selected size over the polymer binder. The method may also include forming a dry stack including the fiber reinforcement and the fillers. The method may also include infusing a polymer resin into the dry stack using a vacuum infusion process. The method may also include forming a fiber reinforced plastic (FRP) laminate including the fiber reinforcement and fillers embedded within a polymer matrix formed from the polymer resin, the fillers having a filler loading of at least 70 parts per hundred parts of infused resin (phr).

In some aspects, the filler loading may be up to 500 phr.

In some aspects, the method may also include selecting a size of the fillers to be large enough to trap locally with the fiber reinforcement while the polymer resin flows in the vacuum infusion process.

In some aspects, the method may further include shaking off a portion of excess fillers over the polymer binder to form the dry stack including the fiber reinforcement and fillers.

In some aspects, the step of forming a fiber reinforced plastic (FRP) laminate may further include curing the polymer resin to form the polymer matrix for the FRP laminate.

In some aspects, the fillers may be substantially uniformly distributed within the polymer matrix.

In some aspects, the fillers may be sized from 10 μm to 1000 μm.

In some aspects, the fillers may be flame-retardant.

In some aspects, the fillers may include aluminum trihydrate (ATH).

In some aspects, the filler loading may be dependent on a content of fiber reinforcement.

In some aspects, the polymer resin may have a viscosity low enough to infuse fiber reinforcement and the fillers.

In some aspects, the polymer binder may include. a spray glue. The step of pre-treating dry fiber reinforcement may include spraying the spray glue over the fiber reinforcement.

In another aspect, a fiber reinforced plastic (FRP) laminate may include one or more fiber reinforcement layers, each fiber reinforcement layer including substantially uniformly distributed fillers being embedded within a polymer matrix, the fillers having a filler loading of at least 70 parts per hundred parts of infused resin (phr).

In some aspects, the FRP laminate may be formed by using a method including: pre-treating dry fiber reinforcement with a polymer binder; spreading fillers of a selected size over the polymer binder; forming a dry stack including the fiber reinforcement and fillers; infusing a polymer resin into the dry stack using a vacuum infusion process; and curing the polymer resin to form the polymer matrix that embeds the fiber reinforcement and the fillers of the FRP laminate.

Additional embodiments and features are set forth in part in the description that follows, and will become apparent to those skilled in the art upon examination of the specification or may be learned by the practice of the disclosed subject matter. A further understanding of the nature and advantages of the disclosure may be realized by reference to the remaining portions of the specification and the drawings, which form a part of this disclosure.

### BRIEF DESCRIPTION OF THE SEVERAL VIEWS OF THE DRAWINGS

The description will be more fully understood with reference to the following figures and data graphs, which are presented as various embodiments of the disclosure and should not be construed as a complete recitation of the scope of the disclosure, wherein:

FIG. 1A illustrates a dry stack including fiber reinforcement, flame-retardant fillers, and binders for fabricating fiber-reinforced polymer laminate using a vacuum infusion process in accordance with one aspect of the disclosure;

FIG. 1B illustrates a dry stack including fiber reinforcement, flame-retardant fillers, and binders for fabricating fiber-reinforced polymer laminate using a vacuum infusion process in accordance with another aspect of the disclosure;

FIG. 2A illustrates a dry stack including two layers of fiber reinforcement, flame-retardant fillers for fabricating fiber-reinforced polymer laminate using a vacuum infusion process in accordance with one aspect of the disclosure;

FIG. 2B illustrates a dry stack including two layers of fiber reinforcement, flame-retardant fillers for fabricating fiber-reinforced polymer laminate using a vacuum infusion process in accordance with another aspect of the disclosure;

FIG. 3 illustrates a flow chart illustrating steps for fabricating fiber reinforced plastic (FRP) panels filled with flame-retardant fillers in accordance with one aspect of the disclosure;

FIG. 4 illustrates an image of the laminate formed by the disclosed vacuum infusion process viewed with backlight in accordance with one aspect of the disclosure; and

FIG. 5 is a sketch illustrating a sectional view of a setup including stacks of fiber reinforcement layers and preloaded fire-retardant fillers prior to vacuum infusion in accordance with one aspect of the disclosure.

### DETAILED DESCRIPTION

The disclosure may be understood by reference to the following detailed description, taken in conjunction with the drawings as described below. It is noted that, for purposes of illustrative clarity, certain elements in various drawings may not be drawn to scale.

### Overview

Typically, vacuum infusion processing of fiber reinforcement laminates cannot be done using a polymer resin (e.g., polymer resin or polyester, among others) with ATH fillers. Some products may be available with a special flow media to achieve high filler loadings, but these products can only achieve filler loading up to 60 phr (parts per hundred resin). Additionally, the special flow media is typically a combustible plastic or may have excessive open space, which results in excess resin and thus lower glass content in a final product.

The vacuum infusion process can consistently make fiber reinforced plastic (FRP) composite products and produce high quality products. However, when the resin is heavily filled with fire-retardant fillers or powder, it is difficult to use vacuum infusion to make an FRP panel or part including heavily loaded fire-retardant fillers. The problem is that the retardant fillers in the resin may be quickly filtered out by the fiber reinforcement and quickly clog the highly compressed dry fiber.

The present technology addresses the need to achieve higher filler loading of flame-retardant fillers by providing a method of fabricating an infusible FRP panel or laminate with high filler loadings without using a special flow media.

The disclosed method infuses an unfilled polymer resin into a dry stack including fiber reinforcement (e.g., fiberglass or carbon fibers) and a pre-loaded fire-retardant powder or fire-retardant fillers by using the vacuum infusion process. The method does not add the fire-retardant fillers to the polymer resin prior to the vacuum infusion process. The flame-retardant fillers may be aluminum trihydrate (ATH) fillers, among others.

The disclosed method includes pre-treating a dry fiber reinforcement fabric or mat with large particle size fire-retardant fillers (e.g., ATH) using a polymer binder, which may adhere the fire-retardant fillers to the fiberglass fabric or mat.

The disclosed method also uses an unfilled low viscosity infusion polymer resin in a normal vacuum infusion process. The low viscosity of the polymer resin allows to properly infuse the fiber reinforcement, e.g., fiberglass or carbon fibers, among others. The selection of the polymer resin may depend on part geometry, size, and infusion process system setup. The low viscosity polymer resins can impregnate natural and synthetic aggregates that are made up of various size particles and create nearly void-free polymer composites.

The disclosed method enables the fabrication of highly filled flame-retardant FRP panels or composite parts using a standard polymer resin infusion process, which does not increase costs in equipment. The disclosed method has lower atmospheric emissions due to a closed mold process. The disclosed method also produces highly filled FRP panels that have less voids and controlled fiber reinforcement contents.

The filler loading on the fiber reinforcement fabric or mat can be optimized to achieve loadings in the range of 70-500 parts per hundred parts of infused polymer resin (phr) by weight for the final FRP panel or laminate, which are difficult to achieve using a normal polymer resin infusion process. Also, the fillers in the final FRP panel or laminate are evenly distributed within the polymer matrix which is formed when the polymer resin is cured. Furthermore, the final FRP panels may be nearly void-fee and have high strength rigid and may have any thickness ranging from less than one millimeter to several meters.

The disclosed technique also allows an unfilled resin to saturate fire-retardant fillers interspersed with fiber reinforcement in ways that are impossible with traditional pre-filled resins. For example, the pre-filled resins cannot be vacuum infused into a fiber reinforcement. Traditional methods for fabricating fire-resistant fiber reinforced composites add fire retardant powder (e.g., ATH) into the unfilled resin to form a thickened blend, then use the thickened blend to wet-out the fibers (e.g., glass fibers). In the traditional method, the fillers are pre-mixed with resin. The fillers can be added up to a maximum amount before the viscosity of the mixed resin becomes so high that the resin could not flow any more.

Also, the traditional methods use open molds, which greatly increase the escape of volatile chemicals into a workplace. In contrast, the disclosed method incorporates dry fillers into dry fiber reinforcement to form a dry blend of materials, then covers the dry blend of materials with an air-tight cover, then infuse an unfilled resin into the vacuum, which is a closed mold process, thus dramatically reduces the amounts of volatile solvents into atmosphere in the workplace. The disclosed method can make the manufacturing of “solid surface” products more environmentally friendly by reducing emissions during the mixing and casting process in the traditional methods.

Also, the disclosed method does not trap air like the traditional process and thus may result in laminates of higher density than a standard casting. The disclosed method may also reduce cycle times with heated molds and fillers.

The disclosed method can create a highly filled fire-retardant fiber reinforced laminate, e.g., higher filler loading than that by pre-filling. The higher filler loading may result in higher fire resistances of the FRP panels. In other words, the filler loadings are proportional to the fire resistances of the FRP panels. With the disclosed methods, the FRP panels may pass even more demanding fire tests. For example, the ASTM E 119 standards (Standard Test Methods for Fire Tests of Building Construction and Materials) may be used to achieve a fire rating for a period, such as 15 minutes, 1 hour, 2 hours, among others. Passing the ASTM E119 tests for 1 hour or 2 hours would open new market opportunities.

Attempts at vacuum infusing highly filled resin with fillers were unsuccessful since the fillers were filtered out by the fiber reinforcements (e.g., fiberglass) as the polymer resin traveled through the fiber reinforcements.

The disclosed process is different from the conventional vacuum infusion process because the dry fillers are preloaded with the dry fibers in advance. Thus, the polymer resin flows through the fillers and does not move the fillers, but only soaks the fillers. The dry fillers are in-situ powder.

The disclosed method can also be used for casting polymer concrete that is nearly void free. Polymer concrete is a composite material where cement hydrate binders that are used in conventional concrete are replaced with polymer binders or liquid resins. In polymer concrete, thermosetting resins may be used as polymer binders due to their high thermal stability and resistance to a wide variety of chemicals. Polymer concrete may also include aggregates that may include silica, quartz, granite, or limestone, among others.

### Filler Loading

The filler loading can be optimized to meet fire resistance requirements, for example, high filler loading ranging from 80 to 200 phr, while infusion resin flow can be maximized.

The filler loading for an infused laminate may vary with polymer matrix content. For example, the filler loading may decrease with the content of the polymer matrix.

The filler loading for the infused laminate may also vary with the fiber reinforcement content. The filler loading in phr can be calculated based on filler weight divided by weight of polymer matrix using Equation (1) as provided below:

$$Filler loading ( phr ) = ( filler weight / polymer matrix weight ) \times 100 = ( filler weight / ( laminate weight - filler weight - fiber reinforcement weight ) ) \times 100 \qquad Equation ( 1 )$$

The filler loading in percentage (%) can be calculated based on Equation (2) as follows:

$$Filler loading ( \% ) = ( weight of filler / laminate weight ) \times 100 \qquad Equation ( 2 )$$

It will be appreciated by those skilled in the art that the fiber reinforcement content in Equations (1) and (2) can be for any fibers. For example, the fiber reinforcement content may be fiberglass content, carbon fiber content, among others.

As an example, the fiber reinforcement is fiberglass. Table 1 shows flame-retardant filler loadings in phr based on various fiberglass contents.

TABLE 1

| Glass content of FRP laminate | |
|---|---|
| (wt %) | Filler loading on resin (phr) |
| 30 | 75 |
| 35 | 117 |
| 40 | 200 |
| 45 | 450 |

As shown in Table 1, the flame-retardant filler loading in phr is highly influenced by glass contents. For a glass content of 30%, the filler loading is estimated to be 75 phr based on Equation (1). For a glass content of 35%, the filler loading is estimated to be 117 phr. For a glass content of 40%, the filler loading is estimated to be 200 phr. For a glass content of 45%, the filler loading is estimated to be 450 phr.

Based on the compressibility of fiber reinforcement under vacuum and polymer resin content, the filler loading can be modified during the infusion process, for example, modified by vacuum pressure during the infusion process or modified by selecting different fiber reinforcement (e.g., fiberglass). As an example, chopped strand mat is known to produce low glass content due to high open space.

In some variations, the filler loading may be equal to or greater than 70 phr. In some variations, the filler loading may be equal to or greater than 80 phr. In some variations, the filler loading may be equal to or greater than 90 phr. In some variations, the filler loading may be equal to or greater than 100 phr. In some variations, the filler loading may be equal to or greater than 150 phr. In some variations, the filler loading may be equal to or greater than 200 phr. In some variations, the filler loading may be equal to or greater than 250 phr. In some variations, the filler loading may be equal to or greater than 300 phr. In some variations, the filler loading may be equal to or greater than 350 phr. In some variations, the filler loading may be equal to or greater than 400 phr. In some variations, the filler loading may be equal to or greater than 450 phr.

In some variations, the filler loading may be equal to or less than 80 phr. In some variations, the filler loading may be equal to or less than 90 phr. In some variations, the filler loading may be equal to or less than 100 phr. In some variations, the filler loading may be equal to or less than 150 phr. In some variations, the filler loading may be equal to or less than 200 phr. In some variations, the filler loading may be equal to or less than 250 phr. In some variations, the filler loading may be equal to or less than 300 phr. In some variations, the filler loading may be equal to or less than 350 phr. In some variations, the filler loading may be equal to or less than 400 phr. In some variations, the filler loading may be equal to or less than 450 phr. In some variations, the filler loading may be equal to or less than 500 phr.

### Dry Stack Including Pre-Loaded Fillers

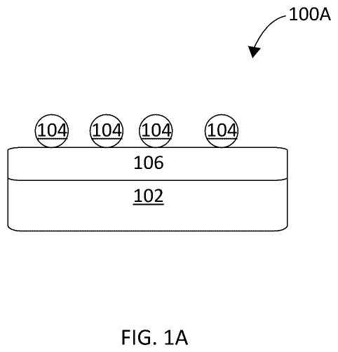

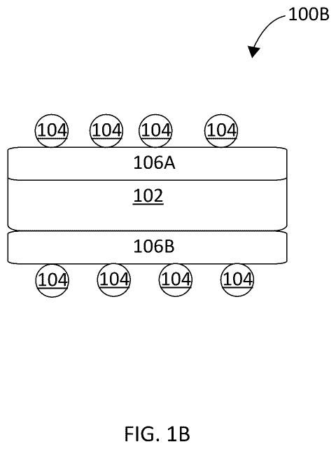

FIG. 1A illustrates a dry stack including fiber reinforcement (e.g., fiberglass or carbon fibers), flame-retardant fillers, and polymer binder for fabricating fiber-reinforced polymer laminate using a vacuum infusion process in accordance with one aspect of the disclosure. As shown, a dry stack 100A includes a layer of fiber reinforcement 102. The dry stack 100A also includes a layer of fillers 104, such as flame-retardant fillers (e.g., ATH fillers), among others. The dry stack 100A may also include a polymer binder layer 106 between the layer of fillers 104 and the fiber reinforcement 102 for holding the fillers 104 to the fiber reinforcement 102. The polymer binder 106 can hold the fillers (e.g., ATH fillers or particles) stable during the handling of the dry fiber reinforcement.

FIG. 1B illustrates a dry stack including fiber reinforcement (e.g., fiberglass or carbon fibers), flame-retardant fillers, and polymer binder for fabricating fiber-reinforced polymer laminate using a vacuum infusion process in accordance with another aspect of the disclosure. As shown in FIG. 1B, a dry stack 100B includes a layer of fiber reinforcement 102, and two layers of fillers 104 on both sides the fiber reinforcement layer 102. The dry stack 100B may also include two polymer binder layers 106A and 106B between the respective layer of fillers 104 and the fiber reinforcement 102 for holding the fillers 104 to the fiber reinforcement 102.

The ATH filler is a common mineral filler in manufacturing a solid surface of a product. The solid surface is a homogeneous pigmented mass formed by the polymerization of thermostable resins and aluminum trihydrate as the mineral filler for a mixture of the resin and the filler. The ATH filler is a white powder that has thermal characteristics that provide translucency and whiteness to the product. Hydrated alumina is dry to the touch. It is chemically combined with three water molecules and has a high melting temperature. ATH is used as a fire retardant in this disclosure.

In some variations, the fiber reinforcement can be any type of fiberglass.

The fillers or particles may be moved during vacuum infusion by the polymer resin, similar to the issue of filtering when the polymer resin is pre-filled with fillers. To avoid the movements of the fillers, the size for the flame-retardant fillers (e.g., ATH fillers) can be selected to be larger enough to allow the fillers or particles to become trapped locally by the fiber reinforcement, while the polymer resin flows around the fillers or particles.

In some variations, the particle size of the fillers (e.g., ATH) may range from 10 μm to 1000 μm.

In some variations, the particle size of the fillers may be equal to or greater than 10 μm. In some variations, the particle size of the fillers may be equal to or greater than 50 μm. In some variations, the particle size of the fillers may be equal to or greater than 100 μm. In some variations, the particle size of the fillers may be equal to or greater than 200 μm. In some variations, the particle size of the fillers may be equal to or greater than 300 μm. In some variations, the particle size of the fillers may be equal to or greater than 400 μm. In some variations, the particle size of the fillers may be equal to or greater than 500 μm. In some variations, the particle size of the fillers may be equal to or greater than 600 μm. In some variations, the particle size of the fillers may be equal to or greater than 700 μm. In some variations, the particle size of the fillers may be equal to or greater than 800 μm. In some variations, the particle size of the fillers may be equal to or greater than 900 μm.

In some variations, the particle size of the fillers may be equal to or less than 1000 μm. In some variations, the particle size of the fillers may be equal to or less than 900 μm. In some variations, the particle size of the fillers may be equal to or less than 800 μm. In some variations, the particle size of the fillers may be equal to or less than 700 μm. In some variations, the particle size of the fillers may be equal to or less than 600 μm. In some variations, the particle size of the fillers may be equal to or less than 500 μm. In some variations, the particle size of the fillers may be equal to or less than 400 μm. In some variations, the particle size of the fillers may be equal to or less than 300 μm. In some variations, the particle size of the fillers may be equal to or less than 200 μm. In some variations, the particle size of the fillers may be equal to or less than 100 μm. In some variations, the particle size of the fillers may be equal to or less than 50 μm.

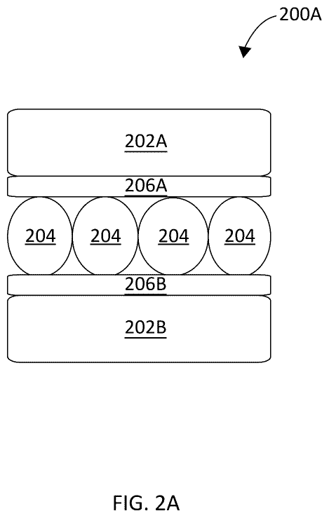

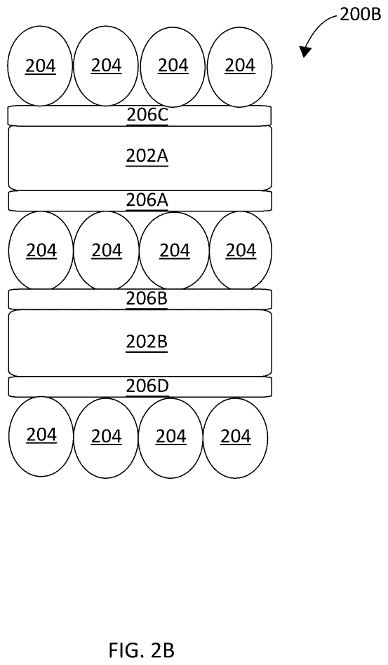

FIG. 2A illustrates a dry stack including two layers of fiber reinforcement, flame-retardant fillers for fabricating fiber-reinforced polymer laminate using a vacuum infusion process in accordance with one aspect of the disclosure. As shown in FIG. 2A, a dry stack 200A may include a layer of fillers 204 sandwiched between a top fiber reinforcement layer 202A and a bottom fiber reinforcement layer 202B. The dry stack 200A may also include a first polymer binder layer 206A that holds the fillers 204 to the top fiber reinforcement layer 202A. The dry stack 200A may also include a second polymer binder layer 206B help hold the fillers to the bottom fiber reinforcement layer 202B. The fillers 204 may be flame-retardant fillers, such as ATH fillers, among others. In this embodiment, one side of the fiber reinforcement layer has fillers. There are no fillers outside the top surface or bottom surface of the fiber reinforcement layer 202A or 202B.

FIG. 2B illustrates a dry stack including two layers of fiber reinforcement, flame-retardant fillers for fabricating fiber-reinforced polymer laminate using a vacuum infusion process in accordance with another aspect of the disclosure. A dry stack 200B may include a top layer of fillers 204 on a top fiber reinforcement layer 202, a middle layer of fillers 204 sandwiched between the top fiber reinforcement layer 202 and a bottom fiber reinforcement layer 202, and a bottom layer of fillers 204 under the bottom fiber reinforcement layer 202. The dry stack 200B may also include two polymer binder layers 206A and 206C, or 206B and 206D on both the top and bottom sides of each of the respective fiber reinforcement layers 202A and 202B, which hold the fillers to each of the respective fiber reinforcement layers. The fillers 204 may be flame-retardant fillers, such as ATH fillers, among others. In this embodiment, both sides of the fiber reinforcement layer 202A or 202B have fillers. There are fillers outside the top surface or bottom surface of the fiber reinforcement layer 202A or 202B.

It will be appreciated by those skilled in the art that a dry stack may include two or more fiber reinforcement layers. It will also be appreciated by those skilled in the art that the pre-loading positions of the fillers may vary, not limited by the examples shown in the disclosure.

In Example 1 given below, the stack included six fiber reinforcement layers. Each fiber reinforcement layer had fillers on both sides of the fiber reinforcement, similar to that shown in FIG. 1B and FIG. 2B. In Example 2 given below, the stack included four fiber reinforcement layers. Each fiber reinforcement layer had fillers on one side of the fiber reinforcement, similar to that shown in FIG. 1A.

### Vacuum Infusion Process

For fabrication of an FRP laminate using vacuum infusion process, the dry stack 100A, 100B, 200A, or 200B can be placed into a mold and then covered with a flexible and impermeable plastic sheet that is sealed around the dry materials. Then, a vacuum can be applied before a polymer resin is introduced. The vacuum can pull air out of a space between the mold and the plastic sheet. Once the vacuum is achieved, the polymer resin can be allowed to bleed into or suck into the space of the dry stack 100A, 100B, 200A, or 200B and can gradually infuse the dry fiber reinforcement 102, 202A, 202B and fillers 104 or 204 with the polymer resin. The process is aided by an assortment of supplies and materials.

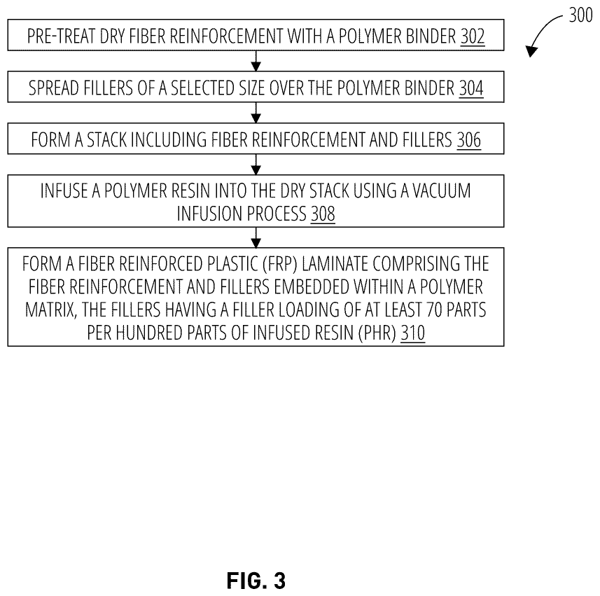

FIG. 3 illustrates a flow chart illustrating steps for fabricating fiber reinforced plastic (FRP) panels filled with flame-retardant fillers in accordance with one aspect of the disclosure.

In operation 302, method 300 may include pre-treating dry fiber reinforcement (e.g., fiberglass or carbon fibers) with a polymer binder. For example, a polymer binder 106, 106A, 206, 206A, or 206B can be applied to the fiber reinforcement 102, 202A, or 202B to pre-treat the dry fiber reinforcement.

In some variations, the polymer binder may include a spray glue.

In operation 304, method 300 may include spreading fillers of a selected size over the polymer binder. For example, the fillers 104 or 204 can spread over the binder 106A or 106B, or 206A, 206B, 206C, 2026D, as illustrated in FIG. 1A or 1B or FIG. 2A or 2B.

In some variations, method 300 may also include selecting a size of the fillers to be large enough to trap locally with the fiber reinforcement (e.g., fiberglass) while the polymer resin flows in the vacuum infusion process.

In some variations, the fillers may be sized from 10 μm to 1000 μm.

In some variations, the fillers may be flame-retardant fillers.

In some variations, the fillers may include aluminum trihydrate (ATH).

In operation 306, method 300 may include forming a dry stack including the fiber reinforcement and fillers. For example, a dry stack 100A, 100B, 200A, 200B, or 502 including the fiber reinforcement 102 or 202A or 202B and fillers 104, 204, or ATH can be formed. The selection of the polymer resin may depend on part geometry, size, and infusion setup. Examples of infusion resin may include Ineos Modar resin line, Ineos Hetron resin line, Scott Bader Crestapol resin line, among others.

In some variations, method 300 may also include shaking off a portion of excess fillers over the polymer binder to form the dry stack including the fiber reinforcement and fillers.

In operation 308, method 300 may include infusing a polymer resin into the dry stack using a vacuum infusion process. For example, the polymer resin is unfilled and has a viscosity that is low enough to infuse fiber reinforcement 102, 202A, 202B, or CSM fiberglass and the fillers 104, 204, or ATH.

In operation 310, method 300 may include forming a fiber reinforced plastic (FRP) laminate comprising the fiber reinforcement and fillers embedded within a polymer matrix formed from the polymer resin, the fillers having a filler loading of at least 70 parts per hundred parts of infused resin (phr).

In some variations, method 300 may also include curing the polymer resin to form the polymer matrix.

In some variations, the filler loading may depend on the content of fiber reinforcement.

In some variations, the filler loading may be up to 500 phr.

In some variations, the polymer resin may be AKA epoxy resin, which is optically transparent, and has low shrinkage and viscosity. The AKA epoxy resin also has excellent adhesion. The AKA epoxy resin in a liquid form is cured with a liquid hardener to form a polymer matrix for the laminate.

In some variations, the polymer resin may be unsaturated polyester, acrylics, or acrylic modified unsaturated polyester, among others.

### EXAMPLES

The following examples are for illustration purposes only. It will be apparent to those skilled in the art that many modifications, both to materials and methods, may be practiced without departing from the scope of the disclosure.

### Example 1

Filled Polymer Resin with Traditional Approach

Experiments were first performed using a commercially available infusion fiberglass reinforcement for use with a polymer resin pre-filled with ATH fillers. However, these trials with filled resins were unsuccessful. A “filtering” effect occurred when trying to infuse fiberglass reinforcement with a polymer resin pre-filled with fillers (e.g., ATH fillers), i.e., the fillers aggregated at a resin entry point, and slowed the flow of the polymer resin or stopped the flow of the polymer resin, and also filtered out the fillers as the polymer resin flow progressed.

A fiber reinforcement mat (e.g., fiberglass mat) was provided by a supplier. The fiber reinforcement mat was designed to be used with infusion processes of polymer resin with high filler loadings. Typically, the fiber reinforcement mat is designed to achieve a filler loading up to 60 phr (parts per hundred resin). However, the filler loading of up to 60 phr is lower than the FRP panels or laminates that require filler loadings in the range of 80 phr to 200 phr, which may achieve specific fire-retardant results.

To increase the filler loading to achieve the flame-retardant results, experiments were performed to infuse the fiber reinforcement mat with a filled polymer resin with fillers, such as an infusion grade resin (e.g., Ineos Modar™ resin) filled with high amounts of fillers (e.g., ATH fillers, 140 phr). However, the polymer resin ceased to flow after the polymer resin traveled for about 6 inches. The ATH fillers were filtered out in the vacuum infusion process for the polymer resin, which created a gradient in particle distributions. The vacuum infusion process with the filled polymer resin was also very slow, which may cause processing issues at larger scales. Furthermore, a gradient was created in the particle distributions, which may be problematic because some portion of the FRP panels may have less fillers than other portions, thus the resulting FRP panels may be fire-retardant than desired. Other processing, cure, and final property issues may arise from the gradient in particle distribution or filler loading across the FRP panels.

Unfilled Polymer Resin with Disclosed Approach

Experiments were then performed by pre-loading the fiber reinforcement mat with the ATH fillers or particles onto the dry fiberglass reinforcement, and then infusing an unfilled polymer resin into the dry fiberglass stack with pre-loaded fire-retardant fillers. A FRP panel or laminate can be formed by curing the polymer resin after the unfilled polymer resin is infused into the dry stack including the fiber reinforcement and pre-loaded fillers.

These experiments demonstrated that unfilled polymer resin (i.e., without fillers in the polymer resin) could travel at much higher speeds than filled polymer resin (i.e., with fillers in the polymer resin), even when the ATH fillers were present on the fiber reinforcement fabric. With the ATH fillers present on the surfaces of the fiber reinforcement mat, a certain amount of ATH fillers can be loaded onto the fiber reinforcement.

Using the vacuum infusion process of the unfilled polymer resin into a dry stack 100 or 200, a loading of about 100% of the fiber reinforcement weight can be obtained when using a chopped strand mat of 0.75 oz per square foot. The FRP laminate could have a filler loading of about 80 phr, with a fiber reinforcement content of about 30% by weight. The filler loading of about 80 phr was higher than the maximum of 60 phr for the special fiber reinforcement mat.

The process for fabricating the FRP laminate was described as follows. First, a stack was formed to include six fiber reinforcement layers, each fiber reinforcement layer included 0.75 oz/sq ft CSM fiberglass reinforcement. ATH fillers, e.g., Huber OE100 (about 90 μm size), were preloaded onto each fiber reinforcement layer. A rectangular laminate was formed to have a size of about 15 inches by 12 inches.

Table 2 lists the dry fiberglass weight and the ATH fillers for each fiber reinforcement layer. As shown in Table 2, a total weight of the dry fiber glass was about 155 g.

TABLE 2
ATH loading per layer of dry fiberglass

| | Dry Fiber | Loaded Fiber | ATH in Loaded |
|---|---|---|---|
| Layer | Glass Weight | Glass Weight | Fiber Glass |
| No. | (g) | (g) | (wt %) |
| 1 | 24.0 | 45.8 | 47.6 |
| 2 | 21.8 | 48.2 | 54.9 |
| 3 | 21.4 | 51.2 | 58.1 |
| 4 | 28.0 | 63.8 | 56.1 |
| 5 | 30.4 | 63.0 | 51.7 |
| 6 | 29.1 | 64.8 | 55.1 |
| Total | 154.7 | 336.8 | 54.1 |

A polymer binder 106, such as a 3M™ Super 77™ spray adhesive, was used to pre-treat the dry fiber reinforcement 102 by spraying the spray glue over the dry fiber reinforcement, such that ATH fillers can adhere to both sides of each fiber reinforcement layer (e.g., CSM fiberglass reinforcement), followed by spreading of ATH fillers 104 over the polymer binder 106, and then excess ATH fillers were lightly shaken off, which lead to a dry stack 100 including fiber reinforcement mat 102 pre-loaded with ATH fillers 104. The pre-loaded fiber reinforcement layer was stable and can be handled without risk of losing filler loading during handling.

After pre-loading the fiber reinforcement layers (e.g., CSM fiberglass) with ATH fillers, the pre-loaded fiber reinforcement layers with ATH fillers were stacked together onto a mold (e.g., glass plate). A typical vacuum assisted resin transfer molding (VARTM) process was setup for infusion of the polymer resin with resin feeding from center to edges.

In the experiments, about 500 g of polymer resin, e.g., Ineos resin (Modar™ 820 TC), was initiated with an initiator, e.g., 2% Arkema Luperox DDM-9 initiator. The Ineos resin was fire-retardant, light weight, cost-effective, and corrosion resistant.

The unfilled polymer resin was then introduced or infused into the stack under vacuum, at about 15 inches mercury column pressure. The unfilled polymer resin had a low viscosity. The infusion of the polymer resin was complete after a few minutes. Then, the stack with the infused polymer resin was cured with infrared (IR) lamps to form a laminate, which was demolded after a few hours and had a final weight of 547 g.

The contents of the fiberglass, ATH fillers, and resin of the laminate were also determined. The laminate included 154.7 g fiberglass or 28.3 wt % fiberglass, 182.1 g ATH fillers or 33.3 wt % ATH fillers, and 210.2 g Modar 820 TC resin or 38.4 wt % resin. The laminate had an ATH filler loading of 86.6 phr, which was calculated based on Equation (1).

The ATH fillers were small, e.g., having a size of about 90 μm. When these small fillers were evenly distributed in the laminate, which were difficult to visibly see with naked eyes. Without the ATH fillers, the laminate would be transparent or clear. With the ATH fillers uniformly distributed, the ATH fillers would block some visible light and make the laminate look cloudy. The evenness of the cloudy color laminate showed that the fillers were evenly distributed.

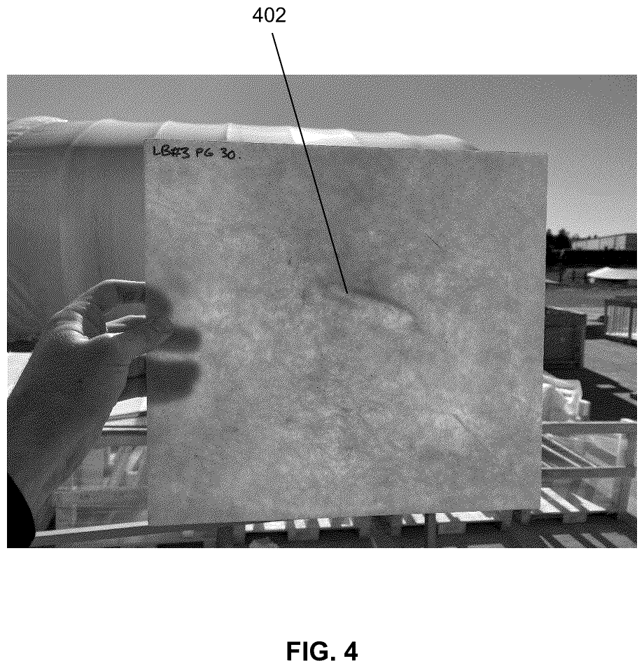

The laminate was viewed with backlight for translucency to evaluate uniformity of filler loading. FIG. 4 illustrates an image of a laminate formed by the disclosed vacuum infusion process viewed with backlight in accordance with one aspect of the disclosure. As shown in FIG. 4, when viewed with backlight, the uniformity of ATH fillers appeared to be relatively even. The small imprint 402 in the center was from the resin port. If fillers had migrated or filtered along the resin flow path, there would be fewer fillers at the center of the laminate and more fillers at the edges of the laminate.

The experiments demonstrated that the approach for applying the ATH fillers onto the fiber reinforcement mat affected the uniformity of the distribution of the fillers. For example, when the ATH fillers were deposited over the dry glass fabric before infusion without binder, experiments showed poor uniformity of the distribution of the ATH fillers. However, when the ATH fillers 106 were adhered to the dry fiber reinforcement using a polymer binder 106, the laminate had substantially uniformly distributed fillers. The use of the polymer binder 106 allows fabrication of FRP panels in curved and vertical geometries while simply depositing the ATH fillers may not work due to gravity.

The experiments also demonstrated that it was possible to pre-load fire-retardant fillers onto the fiber reinforcement in a way that was stable for typical layup handling. It was also feasible to infuse the stack, including pre-loaded fire-retardant fillers onto the fiber reinforcement, with unfilled polymer resin, and to create a laminate with substantially uniform distributions of fillers. By using fillers of a large particle size, and pre-loading the fillers onto the reinforcement fibers (e.g., glass fibers), it is possible to overcome the “filtering” effect by using the traditional method.

The filler loading in the laminate was calculated to be 86.6 phr, which was relatively high and was typically not infusible when the fillers were added to the resin before infusion of the filled resin.

### Example 2

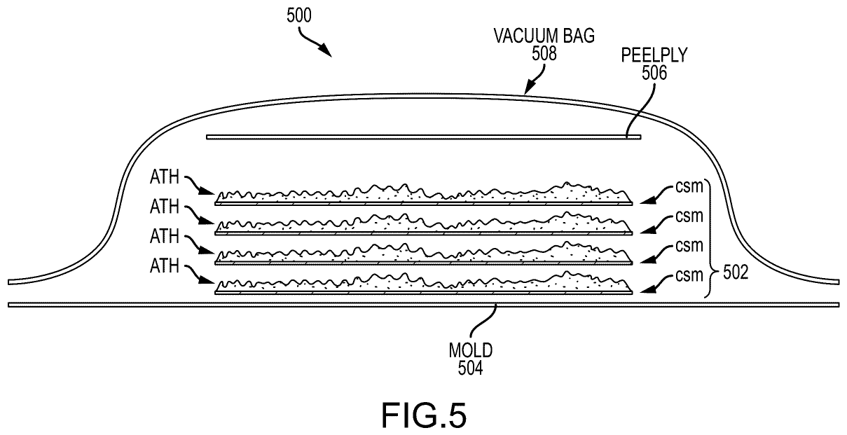

FIG. 5 is a sketch illustrating a sectional view of a setup including stacks of fiber reinforcement layers and preloaded fire-retardant fillers prior to infusion in accordance with one aspect of the disclosure. As shown in FIG. 5, a setup 500 may include a dry stack 502, which includes a number of Chopped Strand Mat (CSM) layers (e.g., four layers) and a number of layers of ATH fillers (e.g., four layers). Each layer of ATH fillers is deposited over the respective CSM layer.

CSM is a random fiber mat that provides equal strength in all directions and is used in a variety of hand lay-up and open-mold applications. Chopped strand mat is produced by chopping continuous strand roving into short lengths (e.g., 1.5 inches to 3 inches) and dispersing the cut fibers randomly over a moving belt to form a “sheet” of random fiber mat. A binder is applied to hold the fibers together and the mat is trimmed and rolled. Because of is random fiber orientation, chopped strand mat conforms easily to complex shapes when wet-out with polyester or vinyl ester resins. Chopped strand mats are available as a roll stock product produced in a variety of weights and widths to suit specific applications.

The setup 500 may also include a mold surface 504 where the stack 502 is placed. The setup 500 may also include a peel ply 506 covering the stack 502, which can be peeled off the stack 502 after forming a FRP laminate by vacuum infusion process. The setup 500 may also include a vacuum bag 508 covering the dry stack 502 and wrapping the sides of the stack 502 toward the mold surface 504.

A resin feed tube may be placed along one long side of the stack, and a vacuum tube may be placed along the other side of the stack. The setup was then prepared for vacuum infusion using a polymer resin. It will be appreciated by those skilled in the art that the positions of the resin feed tube and the vacuum tube may vary.

An example fabrication process for laminate having a target ratio of equal parts glass, resin, and ATH is provided below, including steps 1-7.

Step 1: Four layers of 1.5 oz CSM were cut to the same size, e.g., about 12 inches by 24 inches, and each of the four layers was weighed. An average weight per layer was determined by dividing the total weight of the four layers by 4.

Step 2: ATH was then weighed and put into four cups. Each cup including ATH that equaled to the weight of one layer of CSM above.

Step 3: On a melamine sheet or melamine board, a border was formed using a masking tape defining the size of the CSM that were cut in Step 1. A masking tape dam was created to have a height (e.g., about 2 inches) following the border. Melamine is a chemical compound combined with agents to form a melamine resin, which is a durable thermosetting plastic and has low shrinkage.

Step 4: A first CSM layer was placed into the border of the masking tape.

Step 5: Using a fine mesh strainer, the ATH fillers were evenly cast over the CSM layer by gently tapping the mesh strainer while moving over the CSM layer in even patterns until the strainer was empty. The masking tape dam prevented ATH fillers from leaving the laminate. A chip brush was used to gently push ATH fillers into corners of the CSM layer.

Steps 4 and 5 above were repeated for the remaining CSM layers and ATH fillers.

Step 6: A layer of peel ply 506 was placed over the stack 502 of CSM layers and ATH fillers.

Step 7: The masking tape dam was removed. Then, a resin feed tube was placed along one long side of the stack, and a vacuum tube was placed along the other side of the stack. The setup was then prepared for vacuum infusion using a polymer resin.

By using a polymer resin, e.g., Modar resin, the stack 502 was successfully infused and cured to form a laminate including the stack of CSM layers and ATH fillers embedded within a polymer matrix formed from the polymer resin.

Experiments were performed to demonstrate that the laminate had an equivalent ATH filler loading of 86.6 phr, which may be high enough to pass an ASTM E-84 fire test.

Clause 1. A method for fabricating fiber reinforced plastic (FRP) panels filled with flame-retardant fillers, the method comprising: pre-treating fiber reinforcement with a polymer binder; spreading fillers of a selected size over the polymer binder; forming a dry stack including the fiber reinforcement and the fillers; infusing a polymer resin into the dry stack using a vacuum infusion process; and forming a fiber reinforced plastic (FRP) laminate comprising the fiber reinforcement and fillers embedded within a polymer matrix formed from the polymer resin, the fillers having a filler loading of at least 70 parts per hundred parts of infused resin (phr).

Clause 2. The method of clause 1, wherein the filler loading is up to 500 phr.

Clause 3. The method of clause 1, further comprising selecting a size of the fillers to be large enough to trap locally with the fiber reinforcement while the polymer resin flows in the vacuum infusion process.

Clause 4. The method of clause 1, further comprising shaking off a portion of excess fillers over the polymer binder to form the dry stack including the fiber reinforcement and fillers.

Clause 5. The method of clause 1, wherein forming a fiber reinforced plastic (FRP) laminate further comprises curing the polymer resin to form the polymer matrix for the FRP laminate.

Clause 6. The method of clause 5, wherein the fillers are substantially uniformly distributed within the polymer matrix.

Clause 7. The method of clause 1, wherein the fillers are sized from 10 μm to 1000 μm.

Clause 8. The method of clause 1, wherein the fillers are flame-retardant.

Clause 9. The method of clause 1, wherein the fillers comprise aluminum trihydrate (ATH).

Clause 10. The method of clause 1, wherein the filler loading is dependent on a content of fiber reinforcement.

Clause 11. The method of clause 1, wherein the polymer resin has a viscosity low enough to infuse fiber reinforcement and the fillers.

Clause 12. The method of clause 1, wherein the polymer binder comprises a spray glue, pre-treating dry fiber reinforcement comprising spraying the spray glue over the fiber reinforcement.

Clause 13. A fiber reinforced plastic (FRP) laminate comprising: one or more fiber reinforcement layers, each fiber reinforcement layer comprising substantially uniformly distributed fillers being embedded within a polymer matrix, the fillers having a filler loading of at least 70 parts per hundred parts of infused resin (phr).

Clause 14. The FRP laminate of clause 13, wherein the FRP laminate is formed by using a method comprising: pre-treating dry fiber reinforcement with a polymer binder; spreading fillers of a selected size over the polymer binder; forming a dry stack including the fiber reinforcement and fillers; infusing a polymer resin into the dry stack using a vacuum infusion process; and curing the polymer resin to form the polymer matrix that embeds the fiber reinforcement and the fillers of the FRP laminate.

Clause 15. The FRP laminate of clause 14, wherein the filler has a size large enough to trap locally with the fiber reinforcement while the polymer resin flows in the vacuum infusion process.

Clause 16. The FRP laminate of clause 15, wherein the fillers are sized from 10 μm to 1000 μm.

Clause 17. The FRP laminate of clause 13, wherein the fillers are flame-retardant.

Clause 18. The FRP laminate of clause 13, wherein the filler loading is up to 500 phr.

Clause 19. The FRP laminate of clause 13, wherein the filler loading is dependent on a content of fiber reinforcement.

Clause 20. The FRP laminate of clause 13, wherein the fillers are flame-retardant.

Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Having described several embodiments, it will be recognized by those skilled in the art that various modifications, alternative constructions, and equivalents may be used without departing from the spirit of the invention. Additionally, a number of well-known processes and elements have not been described to avoid unnecessarily obscuring the invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the method and system, which, as a matter of language, might be said to fall therebetween.

What is claimed is:

1. A method for fabricating fiber reinforced plastic (FRP) panels filled with flame-retardant fillers, the method comprising:
pre-treating fiber reinforcement with a polymer binder;
spreading fillers of a selected size over the polymer binder;
forming a dry stack including the fiber reinforcement and the fillers;
infusing a polymer resin into the dry stack using a vacuum infusion process; and
forming a fiber reinforced plastic (FRP) laminate comprising the fiber reinforcement and fillers embedded within a polymer matrix formed from the polymer resin, the fillers having a filler loading of at least 70 parts per hundred parts of infused resin (phr).

2. The method of claim 1, wherein the filler loading is up to 500 phr.

3. The method of claim 1, further comprising selecting a size of the fillers to be large enough to trap locally with the fiber reinforcement while the polymer resin flows in the vacuum infusion process.

4. The method of claim 1, further comprising shaking off a portion of excess fillers over the polymer binder to form the dry stack including the fiber reinforcement and fillers.

5. The method of claim 1, wherein forming a fiber reinforced plastic (FRP) laminate further comprises curing the polymer resin to form the polymer matrix for the FRP laminate.

6. The method of claim 5, wherein the fillers are substantially uniformly distributed within the polymer matrix.

7. The method of claim 1, wherein the fillers are sized from 10 μm to 1000 μm.

8. The method of claim 1, wherein the fillers are flame-retardant.

9. The method of claim 1, wherein the fillers comprise aluminum trihydrate (ATH).

10. The method of claim 1, wherein the filler loading is dependent on a content of fiber reinforcement.

11. The method of claim 1, wherein the polymer resin has a viscosity low enough to infuse fiber reinforcement and the fillers.

12. The method of claim 1, wherein the polymer binder comprises a spray glue, pre-treating dry fiber reinforcement comprising spraying the spray glue over the fiber reinforcement.

13. A fiber reinforced plastic (FRP) laminate comprising:
one or more fiber reinforcement layers, each fiber reinforcement layer comprising substantially uniformly distributed fillers being embedded within a polymer matrix, the fillers having a filler loading of at least 70 parts per hundred parts of infused resin (phr).

14. The FRP laminate of claim 13, wherein the FRP laminate is formed by using a method comprising:
pre-treating dry fiber reinforcement with a polymer binder;
spreading fillers of a selected size over the polymer binder;
forming a dry stack including the fiber reinforcement and fillers;
infusing a polymer resin into the dry stack using a vacuum infusion process; and
curing the polymer resin to form the polymer matrix that embeds the fiber reinforcement and the fillers of the FRP laminate.

15. The FRP laminate of claim 14, wherein the filler has a size large enough to trap locally with the fiber reinforcement while the polymer resin flows in the vacuum infusion process.

16. The FRP laminate of claim 15, wherein the fillers are sized from 10 μm to 1000 μm.

17. The FRP laminate of claim 13, wherein the fillers are flame-retardant.

18. The FRP laminate of claim 13, wherein the filler loading is up to 500 phr.

19. The FRP laminate of claim 13, wherein the filler loading is dependent on a content of fiber reinforcement.

20. The FRP laminate of claim 13, wherein the fillers are flame-retardant.
